(19) United States
(12) Patent Application Publication
(10) Pub. No.: US 2001/0026285 A1
(43) Pub. Date: Oct. 4, 2001

(54) DISPLAY SYSTEM WITH LATENT IMAGE REDUCTION

(76) Inventors: DANIEL TOFFOLO, DEARBORN, MI (US); SILVIU PALALAU, BIRMINGHAM, MI (US); WILLIAMS ROGERS, SOFFIELD, CT (US); MASAZUMI SONE, SALINE, MI (US)

Correspondence Address: TIMOTHY J. HALLER, NIRO, SCAVONE, HALLER & NIRO, 181 WEST MADISON STREET, SUITE 4600, CHICAGO, IL, 60602

(21) Appl. No.: 09/067,132

(22) Filed: Apr. 27, 1998

(51) Int. Cl. G09G 5/00

(52) U.S. Cl. 345/620

(57) ABSTRACT

A display system reduces latent image formation by shifting an image between a first position and a second position, displaced only a few pixels from the first position. Preferably, the image is displayed briefly simultaneously at the first and second positions and then displayed only in the second position for a second predetermined time period.

### BACKGROUND OF THE INVENTION

The present invention relates generally to a display system and a method for reducing latent images in displays, particularly electro-luminescent displays (ELDs), VFDs, FEDs or CRTs, and assuring that the emissive elements of the display “age” more evenly.

The effect of uneven aging of the emissive elements in displays, particularly ELDs displays, is well known. Pixels which are activated more than others will “age” sooner than others. As a result, a “latent” image formed by the “aged” pixels will become visible on the display.

It is known to dim the screen after a period of inactivity by the user, indicated by a lack of input on a user-input device. Alternatively, “screen savers” display moving or changing images which more evenly age the pixels; however, none of these techniques is implemented during use. There may be portions of the display which remain activated for extended periods of time while sufficient activity is occurring in other portions of the screen to prevent the screensaver from activating or the screen to dim.

High resolution reconfigurable displays are being used more frequently in vehicles. Latent images in these displays is a particular problem, since long periods of time without input from a user-input device are not unusual and do not normally mean that the screen can be dimmed or that a “screen saver” can replace the information being displayed. For example, a display which includes vehicle gages, such as the vehicle speedometer, might operate continuously for hours without a user input, but the information must be displayed constantly. Therefore, the known techniques for reducing latent images are inapplicable.

### SUMMARY OF THE INVENTION

The present invention provides a display system and method for reducing the latent image caused by uneven aging of the emissive elements in a display. Generally, the display system displays an image at a first position for a first predetermined time period. The display system then displays the image at a second position only a few pixels displaced from the first position for a second predetermined period of time. Preferably, the image is displayed in the first and second positions simultaneously briefly, and then only in the second position. This reduces the noticeability of the transition of the image from the first position to the second position. In the second position, different pixels will be activated, thus more evenly aging pixels on the screen.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic of the display system of the present invention;

FIG. 2 is the display system of FIG. 1, with the image displayed simultaneously in the first and second positions; and

FIG. 3 is the display system of FIG. 1 with the image displayed in the second position only.

### DETAILED DESCRIPTION OF THE PREFERRED EMBODIMENT

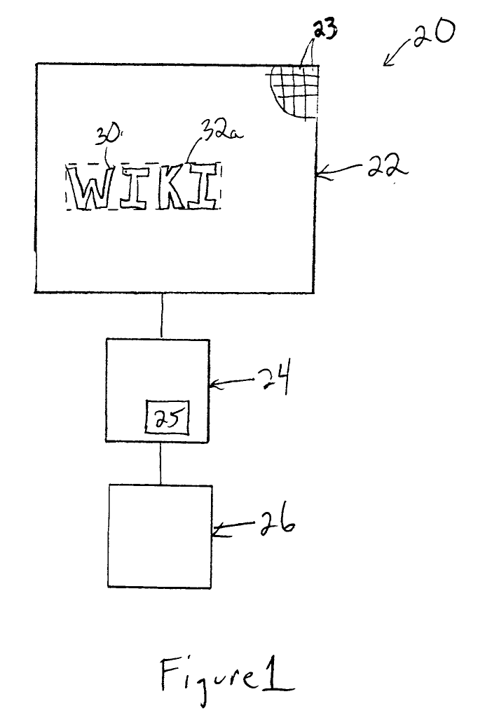

A display system 20 of the present invention is shown schematically in FIG. 1. The display system 20 includes a display 22, such as an ELD, VFD, FED or CRT, having a matrix of pixels 23, as is generally known. The illumination of the pixels 23 in display 22 is controlled by a display controller 24 having a memory 25, such as VRAM. It should be recognized that the exact configuration and software of the display controller 24 will depend upon the type of display 22. The display controller 24 is preferably appropriate to the technology used by the display 22, again, preferably ELD.

The display controller 24 drives the display 22 to illuminate a plurality of pixels in a manner generally known according to a video source 26, which may be a CPU. Based upon the information from the video source 26 stored in the memory 25, the display controller 24 causes a plurality of pixels to be illuminated on display 22, forming an image 30 in a first position 32a on the display 22. Although for exemplary purposes, the image 30 is shown as text, it should be recognized that the image 30 could be any image on display 22, and is preferably the entire image on display 22, including any icons, text or other images.

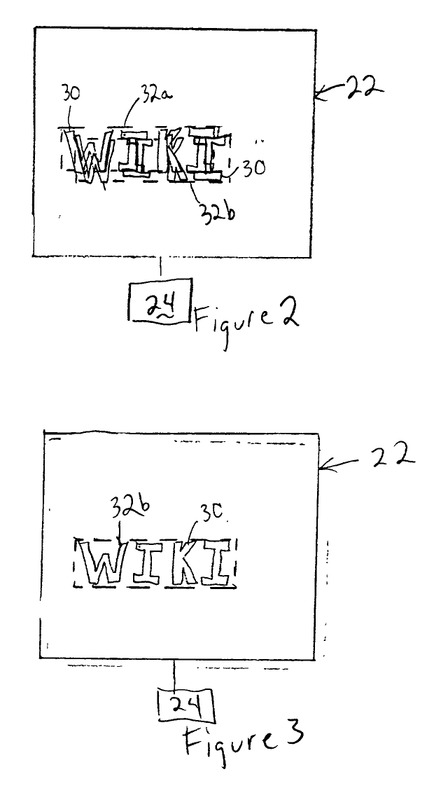

After a first predetermined time period, such as two minutes (or which may be user-defined through software) the display controller 24, via its software, displays the image 30 in a second position 32b, while simultaneously displaying the image 30 in the first position 32a, such as is shown in FIG. 2. This is preferably accomplished by the software in the display controller 24, without actually changing the content of memory 25. Preferably, the second position 32b is displaced by only a single row and/or single column of pixels from the first position 32a. For illustrative purposes, the second position 32b is shown in FIG. 2 displaced diagonally, as shown, from the first position 32a. The image 30 is displayed simultaneously in the first and second positions 32a,b for an interim period, which is preferably approximately 0.1 seconds. Preferably, the intensities of the image 30 in the first position 32a is shifted during the interim period to the image 30 in the second position 32b. For example, the intensity of image 30 at the first position 32a is preferably decreased proportionally as the intensity of the image 30 at the second position 32b is increased. The change in intensity for the images 30a,b is preferably linear over the interim period. In this manner, the total intensity of the display 22 is not altered and the change from the first position 32a to the second position 32b is not noticeable.

After the interim period, the intensity of the image 30 in the first position 32a is zero, leaving only the second image 30b in the second position 32b, as shown in FIG. 3. In this manner, different pixels 23 in display 22 are activated, while the user has not perceived that the image 30 has been moved. It is recognized that some of the same pixels activated by the image 30a in the first position 32a will remain activated by the image 30 in the second position 32b. Therefore, it may be desirable to continue shifting the image 30 to a third position, preferably also downwardly to the right in the same manner as described with respect to FIGS. 1-3. Subsequently, the image may be shifted in a similar manner in other directions, such as to the left and/or upward, until the image 30 eventually returns to the first position 32a.

The total number of pixels by which image 30 is ultimately displaced from the first position 32a will depend upon the number of pixels in display 22, and possibly, the content of image 30. However, preferably for a standard display of 640 by 480 pixels, the third position is displaced three pixels to the right and two pixels downward from the first position 32a. Preferably, the display 22 has more pixels than the image 30 displayed so that there is room to move the image 30 without cutting part of it off.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method for displaying an image on a display comprising a plurality of pixels including the steps of:
a) displaying said image at a first position on said display; and
b) displaying said image at a second position on said display, said second position displaced from said first position.

2. The method of claim 1 further including the steps of:
activating a first set of said plurality of pixels to display said image at said first position in said step a); and
activating a second set of said plurality of pixels to display said image at a second position in said step b).

3. The method of claim 2 further including the steps of:
c) displaying said first set of said plurality of pixels and said second set of said plurality of pixels simultaneously between said steps a) and b);
displaying said image at said first position and not said second position in said step a) and displaying said image at said second position and not said first position in said step b).

4. The method of claim 1, 2, 8, 14 further including the step of:
during said step c), simultaneously decreasing an intensity of said image at said first position while increasing an intensity of said image at said second position.

5. A method of claim 4 wherein said second position is displaced one pixel from said first position, such that the movement of the image from said first position to said second position is relatively imperceivable.

6. The method of claim 1 further including the steps of:
maintaining said image in said first position for a predetermined time period;
displaying said image at said first and second positions simultaneously for a second predetermined time period; and
displaying said image at said second position for a third predetermined time period.

7. The method of claim 1 further including the steps of displaying said image at said first position and not said second position, after said step b).

8. A display system comprising:
a) a display;
b) a display controller activating an image at a first position on said display; and
c) said display controller moving said image to a second position on said display, said second position displaced from said first position.

9. The display system of claim 8 wherein said display controller displays said image at said first position and said second position simultaneously while moving said image from said first position to said second position.

10. The display system of claim 9 wherein said display controller simultaneously decreases an intensity of said image at said first position while increasing an intensity of said image at said second position while moving said image.

11. The display system of claim 10, wherein said second position is displaced one pixel from said first position, such that the movement of the image from said first position to said second position is relatively imperceivable.

12. The display system of claim 11 wherein said display controller maintains said image in said first position for a predetermined time period, said display controller displaying said image at said first and second positions simultaneously for a second predetermined time period; and said display controller displaying said image at said second position for a third predetermined time period.

13. The display system of claim 12 wherein said display controller includes a memory storing information regarding the image to be displayed, said display controller displaying said image at said first position, at said second position and at said first and second positions simultaneously without altering said memory.

14. A display system comprising:
a) a display;
b) means for activating an image at a first position on said display; and
c) means for moving said image to a second position on said display, said second position displaced from said first position.

15. The display system of claim 14 further including means for displaying said image at said first position and said second position simultaneously while moving said image from said first position to said second position.

16. The display system of claim 15 further including means for simultaneously decreasing an intensity of said image at said first position while increasing an intensity of said image at said second position while moving said image.
